(19) United States
(12) Patent Application Publication
(10) Pub. No.: US 2016/0118841 A1
(43) Pub. Date: Apr. 28, 2016

(54) WIRELESS POWER CHARGING STATION

(71) Applicant: The Wiremold Company, West Hartford, CT (US)

(72) Inventors: Mark Makwinski, Cromwell, CT (US); Richard R. Picard, West Hartford, CT (US)

(21) Appl. No.: 14/925,268

(22) Filed: Oct. 28, 2015

Related U.S. Application Data
(60) Provisional application No. 62/069,479, filed on Oct. 28, 2014.

(51) Int. Cl. H02J 7/02; H02J 7/00

(52) U.S. Cl. CPC H02J 7/025; H02J 7/0044

(57) ABSTRACT

A wireless power charging station includes a bowl-shaped body with a bottom portion and a sidewall extending upwardly from the bottom portion. A wireless power transmitter is disposed within the bottom portion and connected to a power supply supplying power thereto. The wireless power transmitter is configured to transmit a wireless charging field upwardly from the bottom portion to a top of the sidewall.

### CROSS-REFERENCE TO RELATED APPLICATION

This application claims the priority to U.S. Provisional Patent Application No. 62/069,479, filed Oct. 28, 2014, the contents of which is hereby incorporated herein by reference in its entirety.

### TECHNICAL FIELD

The present disclosure relates to wireless power charging and, more particularly, to wireless power charging stations for portable electronic devices.

### BACKGROUND

Portable electronic devices require periodic charging. It can be inconvenient, however, to utilize power cords and cables for charging portable electronic devices because, oftentimes, the power cords or cables for particular electronic devices are not interchangeable. Additionally, plugging portable electronic devices into power outlets for charging using power cords or cables may inhibit use of the portable electronic devices by effectively tethering the portable electronic devices to the outlets, thereby limiting the ability to use the portable electronic devices while they are being charged.

### SUMMARY

According to the present disclosure, a wireless power charging station includes a bowl-shaped body with a bottom portion and a sidewall extending upwardly from the bottom portion. A wireless power transmitter is disposed within the bottom portion and connected to a power supply supplying power thereto. The wireless power transmitter is configured to transmit a wireless charging field upwardly from the bottom portion to a top of the sidewall.

These and other objects, features and advantages of the present disclosure will become apparent in light of the detailed description of embodiments thereof, as illustrated in the accompanying drawings.

### BRIEF DESCRIPTION OF THE DRAWINGS

FIG. 1 is a side perspective view of an exemplary charging bowl;

FIG. 2 is a side cross-sectional view of an exemplary charging bowl; and

FIG. 3 is a side perspective view of an exemplary charging bowl.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application.

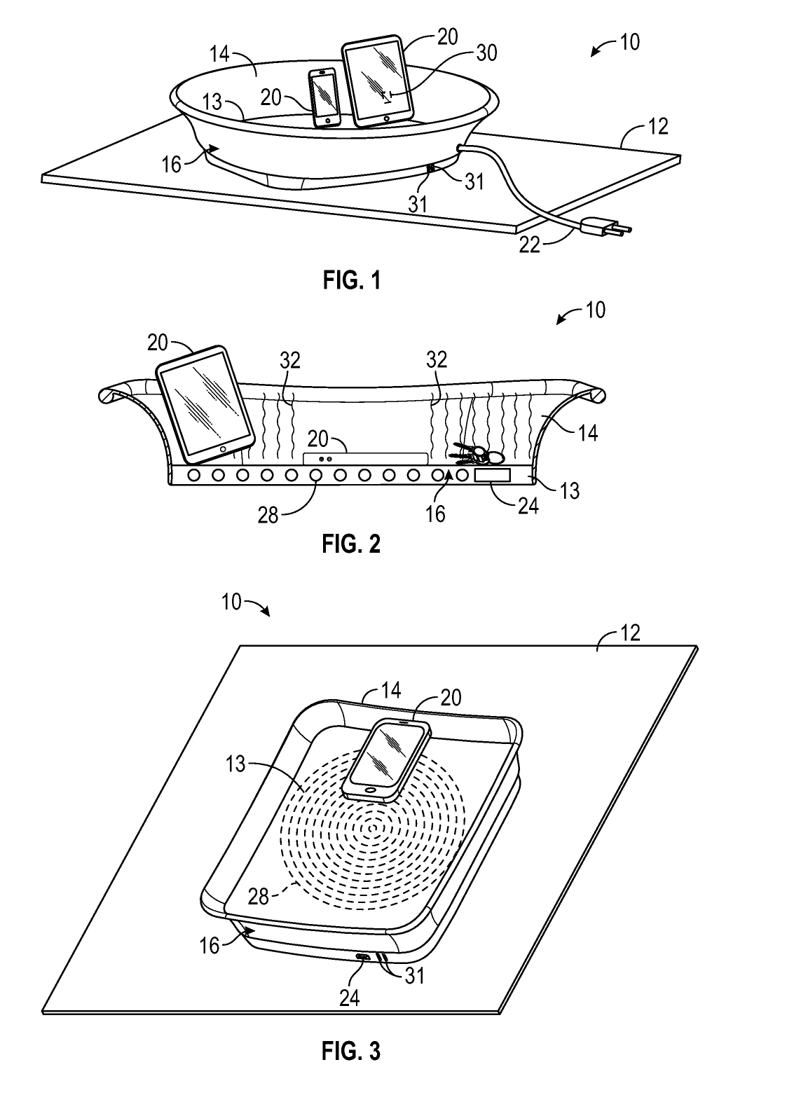

Referring to FIGS. 1 and 2, a charging tray or bowl 10 for use on a table or surface 12 includes a bottom portion 13 and sidewalls 14 extending from the bottom portion. The sidewalls 14 may have a circular shape, ovular shape, square or rectangular shape, inverted frusto-conical shape, inverted frusto-pyrimidal shape, as seen in FIG. 3, or any other sidewall shape that, together with the bottom portion 13, provides the charging bowl 10 with a bowl-like shape. The bowl 10 also includes a wireless portion 16 for wirelessly transmitting charging power (i.e., current and voltage) to wirelessly charge electronic devices 20, such as for example, mobile phones, tablets, laptops or the like. The charging bowl 10 may also include a power cord 22 for providing power thereto, as shown in FIG. 1. Alternatively or in addition thereto, the bowl 10 may include a battery power portion 24, as shown in FIG. 2, such as a rechargeable power supply, a replaceable battery or the like.

The wireless portion 16, including a magnetic resonant wireless power transmitter or coil 28, provides power to compatible receivers 30 disposed in devices 20 placed on/into the charging bowl 10. The wireless portion 16 may implement any suitable wireless power standards/technologies for wirelessly transmitting charging power to one or more electronic devices 20.

The charging bowl 10 may also include one or more USB ports 31 operatively connected to the power cord 22 or battery power portion 24 for supplying power to one or more electronic devices 20 via a cable or corded connection. The one or more USB ports 31, thus, allow electronic devices 20, that may or may not included compatible receivers 30 for wireless charging, to be plugged in and charged by the charging bowl 10 through a cable or corded connection.

The transmitter or coil 28 is substantially planar and is accommodated within the bottom portion 13 of the bowl 10. For example, the transmitter or coil 28 may be a Titan 16 Watt Power Transmitting Unit manufactured by Gill Electronics or any other similar transmitter or coil. The transmitter or coil 28 is connected to and receives power from the power cord 22 and/or the battery power portion 24. The transmitter or coil 28 is tuned to transmit a charging field 32 having a height that extends to at least the top of the sidewalls 14 of the charging bowl 10 by throwing the charging field 32 outward. The sidewalls 14 of the bowl are sufficiently shallow to allow receivers 30 of devices 20 to be within the range of the transmitter 28 to charge devices 20 placed within the bowl 10. For example, the sidewalls may extend to a height in the range of twenty-five (25) millimeters to forty-five (45) millimeters or the sidewalls may extend to a height smaller than twenty-five (25) millimeters, such as five (5) millimeters. Devices 20 may be placed either in a flat position or at an angle in the bowl and still be wirelessly charged therein. Angled positioning of the devices within the bowl advantageously allows for the bowl 10 to accommodate more devices therein.

The charging bowl 10 allows convenient wireless charging of various devices 20 while keeping various devices neatly in one place and without requiring separate power cords or cables for each device. Additionally, other items 32, such as for example, keys and coins can also be placed in the bowl 10 upon entering the house and will not interfere with the charging function of the bowl 10. Additionally, the charging bowl 10 can be conveniently moved and placed in any location.

While the present disclosure has been illustrated and described with respect to a particular embodiment thereof, it should be appreciated by those of ordinary skill in the art that various modifications may be made without departing from the spirit and scope of the present disclosure.

What is claimed is:

1. A wireless charging station comprising:
a bowl-shaped body including a bottom portion and a sidewall extending upwardly from the bottom portion; and
a wireless power transmitter disposed within the bottom portion and connected to a power supply;
wherein the wireless power transmitter is configured to transmit a wireless charging field upwardly from the bottom portion.

2. The wireless charging station according to claim 1, wherein the power supply includes a rechargeable battery configured to supply power to the wireless power transmitter.

3. The wireless charging station according to claim 2, additionally comprising a power cord connectable to the rechargeable battery to supply power thereto.

4. The wireless charging station according to claim 1, wherein the power supply includes a power cord extending outwardly from the bowl-shaped body.

5. The wireless charging station according to claim 1, additionally comprising at least one USB port disposed on an exterior of the bowl-shaped body and operatively connected to the power supply.

6. The wireless charging station according to claim 5, wherein the at least one USB port is disposed on an exterior of the bottom portion.

7. The wireless charging station according to claim 1, wherein the sidewall has a height of at least 25 millimeters.

8. The wireless charging station according to claim 7, wherein the height of the sidewall is in the range of 25 to 45 millimeters.

9. The wireless charging station according to claim 1, wherein the bottom portion includes a substantially flat lower surface.

10. The wireless charging station according to claim 1, wherein the sidewall is substantially circular.

11. The wireless charging station according to claim 1, wherein the sidewall has an inverted frusto-conical shape.

12. The wireless charging station according to claim 1, wherein the wireless power transmitter is configured to transmit the wireless charging field upwardly from the bottom portion to a top of the sidewall.

13. The wireless charging station according to claim 1, wherein the wireless power transmitter includes a planar coil.

14. A portable wireless charging station comprising:
a body including a bottom portion and a sidewall extending upwardly from the bottom portion;
a wireless power transmitter disposed within the bottom portion and connected to a power supply; and
a power cord connectable to the power supply to supply power thereto;
wherein the wireless power transmitter is configured to transmit a wireless charging field upwardly from the bottom portion to a top of the sidewall.

15. The portable wireless charging station according to claim 14, wherein the power supply includes a rechargeable battery.

16. The portable wireless charging station according to claim 14, additionally comprising at least one USB port disposed on an exterior of the bottom portion of the body and operatively connected to the power supply.

17. The portable wireless charging station according to claim 14, wherein the sidewall has a height of at least 25 millimeters.

18. The portable wireless charging station according to claim 17, wherein the height of the sidewall is in the range of 25 to 45 millimeters.

19. The portable wireless charging station according to claim 14, wherein the bottom portion includes a substantially flat lower surface.

20. The portable wireless charging station according to claim 14, wherein the sidewall has an inverted frusto-conical shape.

21. A portable wireless charging station comprising:
a bowl-shaped body including a bottom portion and a sidewall extending upwardly from the bottom portion at a periphery of the bottom portion to a height of at least 25 millimeters, the bottom portion having a flat lower surface configured to contact a flat supporting surface and a flat upper surface configured to support electronic devices;
a wireless power transmitter including a planar coil disposed within the bottom portion; and
a power supply connected to the wireless power transmitter and configured to supply power thereto, the power supply including a power cord connectable to a power source;
wherein the wireless power transmitter is configured to transmit a wireless charging field upwardly from the bottom portion to a top of the sidewall.
